(19) United States
(12) Patent Application Publication
(10) Pub. No.: US 2003/0201576 A1
(43) Pub. Date: Oct. 30, 2003

(54) Injection mold apparatus and method

(76) Inventors: Michael Smith, Smithton, IL (US); Thomas Skorch, Dubois, IL (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/395,953

(22) Filed: Mar. 24, 2003

Related U.S. Application Data
(60) Provisional application No. 60/375,507, filed on Apr. 25, 2002.

(51) Int. Cl. B29C 45/66

(52) U.S. Cl. 264/328.1; 425/595; 425/169

(57) ABSTRACT

An injection mold apparatus is configured with one or more secondary mold locks and matched shear parting lines to prevent relative movement of individual mold elements parallel to, and normal to a mold opening and closing axis. The secondary mold locks operate conjunction with a primary mold clamping unit to secure the injection mold in a closed configuration against movement parallel to a mold opening and closing axis. The matched shear parting lines are orientated at an angle relative to the mold opening and closing axis, defining contact surfaces which secure the injection mold elements against relative movement normal to the mold opening and closing axis.

### CROSS-REFERENCE TO RELATED APPLICATIONS

The present application is related to, and claims priority from, U.S. Provisional Application Serial No. 60/375,507 filed on Apr. 25, 2002, which is herein incorporated by reference.

### STATEMENT REGARDING FEDERALLY SPONSORED RESEARCH

Not Applicable.

### BACKGROUND OF THE INVENTION

The present invention relates generally to injection molding machines in which two or more elements of a mold are held together during an injection and cooling process, and more particularly, to a secondary clamping system configured to lock the mold elements along matched mold parting lines in a closed configuration during the injection and cooling process.

Thermoplastic and elastomer injection molding is employed to produce a wide variety of products, ranging from small children's toys to large unitary automotive body panels, such as bumper fascias. During an injection molding process, plastic pellets are feed from a supply into a mold injection unit, wherein they are heated and melted prior to injection under pressure into the mold through one or more passages. Typically, the molten plastic is injected into the mold under pressures on the range from 70 MPa to 200 Mpa, sufficient to force the molten plastic into all of the voids present in the mold structure, and to drive out any air bubbles present. Coolant circulating through passages within the mold elements draws out residual heat from the molten plastic, cooling it rapidly and uniformly so that the finished product can be quickly removed and the mold reset for the next cycle. For small products, the elements of the mold may be held together with relatively low forces during the injection molding and cooling process, however, as the products become larger, significantly greater forces are required to maintain the mold elements in a closed and stable configuration.

Conventional large scale injection molding machines employ one or more hydro-mechanical clamping unit to secure the elements of the injection molding unit in a closed configuration during the injection phase and cooling phase of the molding process. However, hydro-mechanical clamping units do not provide a positive lock between the cavity and core parting lines of the mold elements, and rely only upon the continuous exertion of hydraulic pressure to maintain the mold elements in the closed configuration. During the mold process, if the hydraulic pressure to the hydro-mechanical clamping unit is not maintained at a required level, the mold elements will separate, resulting in a damaged or defective end product. Larger molds, such as those used to form automotive components, require significantly greater clamping pressures to maintain the mold elements in the closed position, limiting the size of a product which can be molded by the capacity of the clamping unit.

Maintaining the hydraulic pressure to a hydro-mechanical clamping unit during both the injection phase and the cooling phase of the molding process requires a significant energy expenditure, as well as an extended cycle time, during which the pressure is removed to open the mold, and reintroduced to close and hold the mold for a subsequent cycle. Accordingly, the size of the product which can be molded is limited by the capacity of the mold clamping unit. Improvements which increase the size of a product which can be molded using a given mold clamping unit would be of great benefit in the injection molding industry.

It is additionally known that during the injection phase, when molten material is injected into the mold cavity under high pressures, flexing and shifting can occur between the elements of the mold, along conventional parting lines which are orientated parallel to the mold base (e.g. orthogonal to the mold opening and closing axis). This flexing and shifting permits small quantities of molten material to flow along the parting lines, resulting in undesirable waste material, i.e. “flash”, on the edges of the finished product. Flash material must be removed prior to painting or finishing of the product, and requires extensive additional labor and cost.

Accordingly, there is a need in the injection molding industry for a mold clamping unit design having an increased product size limitation, and which does not rely exclusively upon the continuous exertion of a hydraulic pressure to maintain the elements of a mold in a closed configuration during the high-pressure injection and cooling phases of a molding operation. A further need is for a mold clamping unit which provides a positive lock between the individual mold elements, eliminating the risk of product loss associated with a failure to maintain a required level of hydraulic lock pressure, and to configure a mold with matched parting lines which are resistant to flexing and shifting during the injection phase of the molding process, thereby reducing or eliminating material flash on the finished product.

### BRIEF SUMMARY OF THE INVENTION

Briefly stated, a first embodiment of the present invention provides a secondary mold lock for use in conjunction with a primary mold clamping unit to secure the elements of an injection mold in a closed configuration against movement parallel to the mold axis or draw direction. The secondary mold lock comprises a hydraulically actuated locking element configured to seat within, a tool cavity lock and to engage with a tool core lock in the injection mold, reducing the clamp pressure required to hold the mold elements in a closed configuration. The secondary mold lock is further configured with a sensing device adapted to communicate with the injection mold process controller and indicated the locked or unlocked state of the secondary mold lock. Signals provided by the sensing device are utilized to ensure a proper sequence of events during a molding operation, thereby preventing damage to the mold unit or lock mechanisms.

A second embodiment of the present invention incorporates matched shear parting lines between a mold core and mold cavity of an injection mold. Each matched shear parting line is orientated at an angle relative to the mold base plane. The mold base plane is normal to the axis along which the mold opens and closes. The matched shear parting line contours define a plurality of protrusions and matching recesses, such that the mold core and mold cavity seat along contact surfaces when the mold is closed. The plurality of protrusions and matching recesses defined by the matched shear parting lines are configured to resist movement and flexing of the mold cavity and core elements perpendicular to the mold axis or draw direction during the injection phase of a molding process, reducing the clamp pressure required to hold the mold elements in the closed position.

A third embodiment of the present invention incorporates both the secondary mold lock elements and the matched shear parting lines in an injection molding apparatus to provide a positive interlock between the mold elements, preventing the mold elements from opening, shifting, or flexing during the injection molding operation, while reducing the clamp pressure required to hold the mold elements closed during the molding operation.

During an injection molding operation, a primary clamping unit is first utilized to position the first and second mold elements in a closed configuration, and to then compress, using hydraulic pressure from a primary source, the mold elements to a desired tonnage. Next, one or more secondary mold locks of the present invention are engaged, preferably using hydraulic pressure from a secondary source. During engagement, each locking element of a secondary mold lock passes through a tool cavity lock on the first mold element, and engages with a tool core lock on the second mold element thus mechanically securing the first and second mold elements in a closed configuration against movement parallel to the mold axis or draw direction. Upon engagement between the secondary locking elements and the tool core locks, a signal is sent from a lock position sensor on each secondary lock to the mold process control unit indicating that a positive lock has been achieved, after which the injection phase of the molding process can proceed. During the injection phase of the molding process, protrusions and recesses defined by matched shear parting lines between the first and second mold elements resist relative flexing and movement of the mold elements as molten material is injected under high pressures into the cavity between the mold elements. By resisting flexing and movement of the mold elements, the matched parting lines substantially eliminating the formation of waste flash at the edges of the product cavity. Following the injection phase and the cooling of the injected material, the primary clamping unit and secondary mold locks are disengaged, signaling the mold process control unit to open the mold elements and to eject the molded product, and permitting the molding cycle to repeat.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

In the accompanying drawings which form part of the specification:

FIG. 1 is a side-sectional view of a prior art injection molding apparatus, illustrating conventional parting lines orientated substantially parallel to the core side mold base plane;

FIG. 2 is a partial sectional view of a simplified injection mold for an injection molding apparatus, illustrating the placement of a secondary mold clamping lock of the present invention relative to the mold elements;

FIG. 3 is an enlarged sectional view of a portion of FIG. 2, illustrating elements of one embodiment of the secondary mold clamping lock;

FIG. 4 is a schematic diagram further illustrating components of the secondary mold clamping lock shown in FIG. 2;

FIG. 5 is a perspective view of a secondary mold clamping lock of the present invention;

FIG. 6 is a perspective view of a tool core lock of the present invention for receiving a secondary mold clamping lock;

FIG. 7 is a side-sectional view of an injection molding apparatus of the present invention, illustrating shear parting lines orientated at an angle relative to the core side mold base plane; and

FIG. 8 is a perspective view of one side of an injection mold, illustrating a protrusion defined by an angled shear parting line surface of the present invention.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

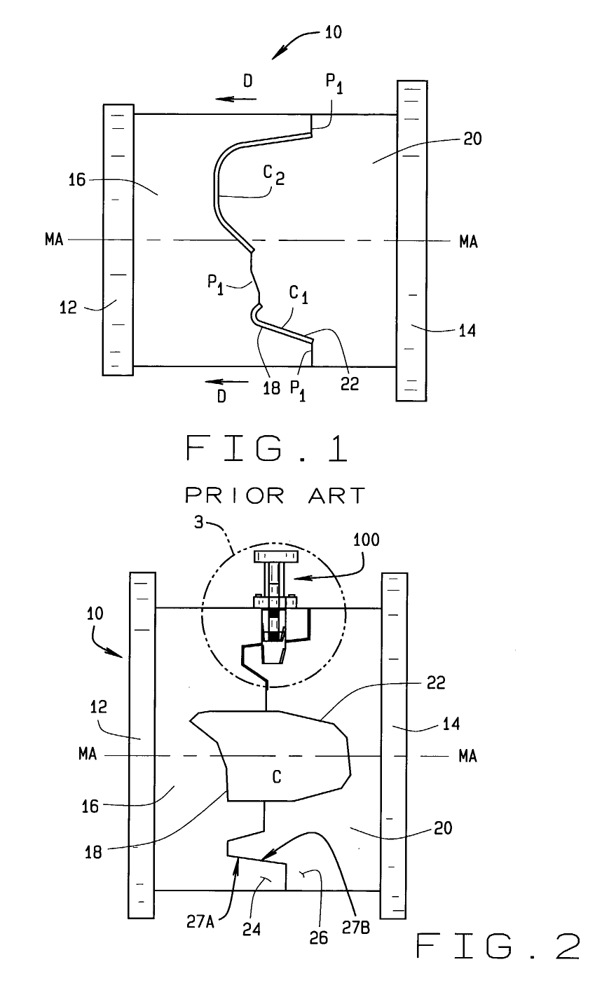

Turning to FIG. 1, a conventional injection mold is shown generally at 10. The injection mold 10 includes two platens, 12 and 14, at least one of which is configured for longitudinal movement along a mold axis MA, commonly referred to as a draw direction D, toward and away from the other in a conventional manner for opening and closing of the injection mold 10. Typically, relative movement of platen 12 or 14 is actuated by a primary hydraulic unit (not shown). Affixed to platen 12 is a die or mold element 16, commonly referred to as a cavity side mold, having a face 18 defining a portion of an injection molded product (not shown). Correspondingly, a die or mold element 20, commonly referred to as a core side mold, is affixed to platen 14, opposite from die or mold element 16, and includes a face 22 defining an additional portion of the injection molded product.

In the closed configuration shown in FIG. 1, the face 18 of mold element 16 and the face 22 of mold element 20 are brought into register at a series of contact points, commonly referred to as net points, defining one or more voids or cavities C in the shape of the injection molded product, into which molten plastic material is injected under high pressure. Where the face 18 and face 22 are brought into direct contact, no cavity is present, and a mold parting line P is established. The above described components are of standard construction common to injection molding machines, and the details thereof, as well as common variations thereof, will be obvious to those familiar with the art.

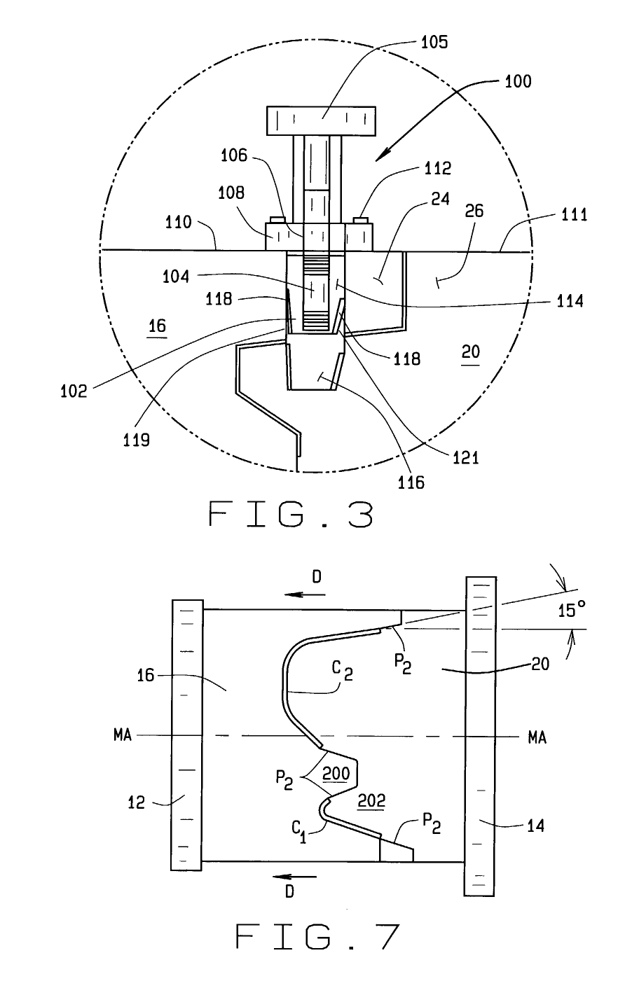

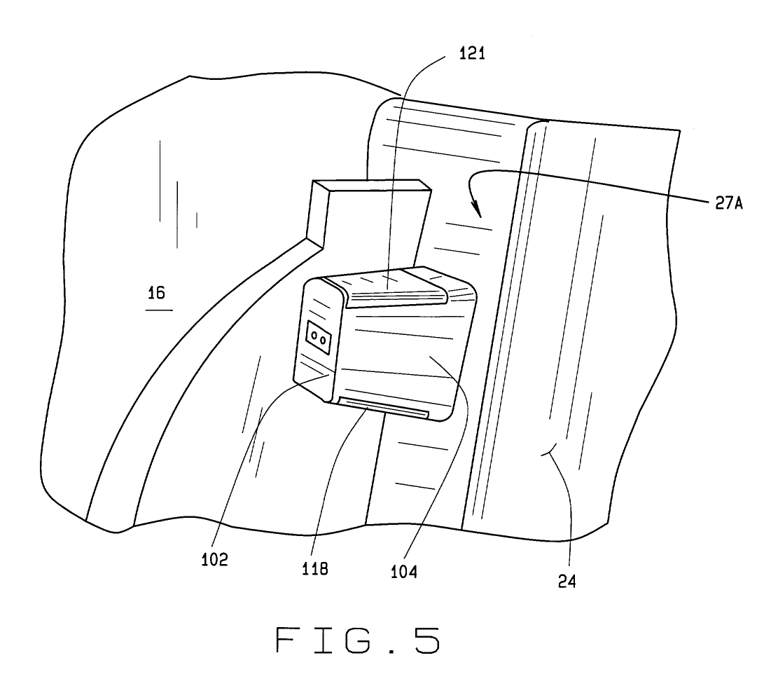

To facilitate axial alignment and interlocking of the mold element 16 and 20 in the closed positions in accordance with the principal features of the present invention, mold element 16 is modified to include a peripheral ridge 24 adapted to seat within a corresponding peripheral channel 26 in mold element 20, as seen at FIGS. 2-6. The peripheral ridge 24 is defined by an engagement surface 27A, while the peripheral channel 26 is defined by a matching engagement surface 27B, both of which generally extend in the direction of draw D.

One or more secondary mold lock units 100 are affixed to the exterior peripheral surface 110 of mold element 16, adjacent the peripheral ridge 24. Each secondary mold lock unit 100 is orientated with an axis generally transverse to the mold axis MA or draw direction D for use in conjunction with a primary mold clamping unit (not shown) to secure the injection mold 10 in a closed configuration.

In a first embodiment, each secondary mold lock 100 comprises a locking wedge 102, secured to one end of a shaft 104. The opposite end of shaft 104 is seated within a secondary hydraulic actuator 105. The shaft 104 is adapted for axial movement through a bore 106 in a base plate 108 which is secured to the exterior peripheral surface 110 of the mold element 16 by means of retaining bolts 112. The locking wedge 102 is movable within a tool cavity lock or bore 114 extending through peripheral ridge 24 the first mold element 16. The locking wedge 102 is preferably orientated normal to the mold axis MA or draw direction to engage a corresponding tool core lock or receptacle 116 with a shear fit in the peripheral channel 26 of the second mold element 20. In an alternate embodiment of the present invention, the locking wedge 102 is orientated at an angle relative to the mold axis MA or draw direction to engage a correspondingly orientated tool core lock or receptacle 116 with a shear fit.

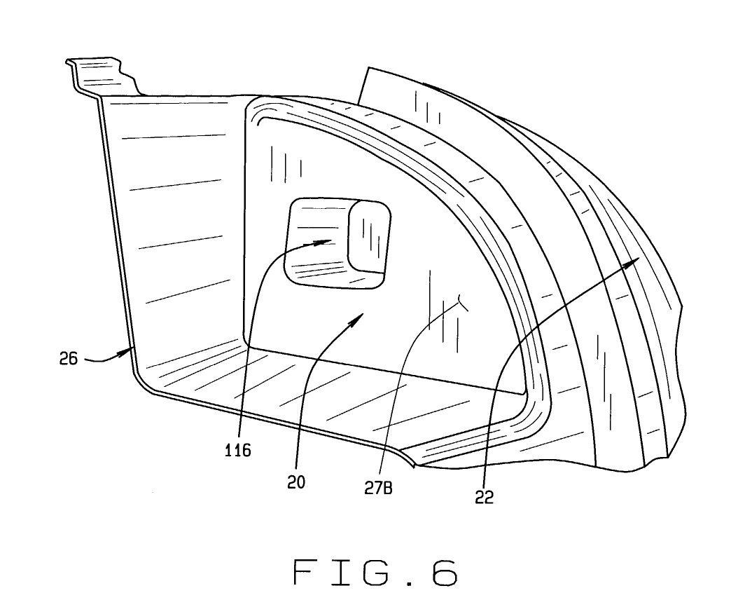

The locking wedge 102 is further configured to receive one or more removable shim plates 118, accommodating for wear and facilitating the holding and release of the locking wedge 102 from the receptacle 116. Preferably, the holding face or surface 119 of the locking wedge 102 is angled at 3.0 degrees relative to the direction of travel, while the release face or surface 121 of the locking wedge 102 is angled at 7.0 degrees relative to the direction of travel. Receptacle 116, shown in FIG. 6 is complimentarily configured to receive locking wedge 102 in a wedging relation. During a locking operation, insertion of the locking wedge 102 into the receptacle 116 generates a compressive force urging the mold elements 16 and 20 together. The compressive force, together with the positive engagement between the locking wedge 102 and the receptacle 116 resists movement of the mold elements 16 and 20 parallel to the mold axis MA or draw direction D.

Optionally, the configuration of the locking wedge 102 may be altered by the use of the removable shim plates 118. Changes in the wedge width and angles can accommodate for wear to the outer surfaces of the wedge and to the surfaces of the corresponding tool core lock or receptacle 116. Changes in the wedge angles of the, either symmetrically by adding shim plates 118 to both sides of the locking wedge 102, or asymmetrically by adding shim plates 118 to only one side of the locking wedge 102 to alter the holding and release angles corresponding to the mold elements.

Those of ordinary skill in the art will recognize that a several variations to the placement of the secondary mold lock 100 are possible. For example, the configuration of the injection mold 10 may be altered such that the secondary mold lock units 100 are affixed to the exterior peripheral surface 111 of mold element 20, instead of the surface 110 of mold element 16. In such a configuration, the locking wedge 102 is movable within a tool cavity lock or bore in a peripheral ridge on the second mold element 20, to engage a corresponding tool core lock or receptacle in a peripheral channel of the first mold element 16.

Alternatively, one or more secondary mold locks 100 may be affixed to the exterior peripheral surface 110 of mold element 16, and one or more additional secondary mold locks 100 may be affixed to the exterior peripheral surface 111 of mold element 20.

It will be further recognized that several variations to the structure of the secondary mold lock 100 are possible, each of which providing a positive match between the first mold element 16 and the second mold element 20. For example, the locking wedge 102 may be replaced by a locking cylinder or shaft, adapted to pass through a fitted bore in one mold element and to engage a matching receiving bore in the second mold element. Alternatively, the locking wedge 102 may be replaced by a threaded shaft, adapted to pass through a bore in one mold element and to engage a tapped bore in the second mold element.

Actuation of each secondary mold lock 100 is not restricted to the use of a secondary hydraulic cylinder. For example, each secondary mold lock may be actuated by a mechanical transmission system, an electrical motor, or other conventional system adapted for providing extension and retraction.

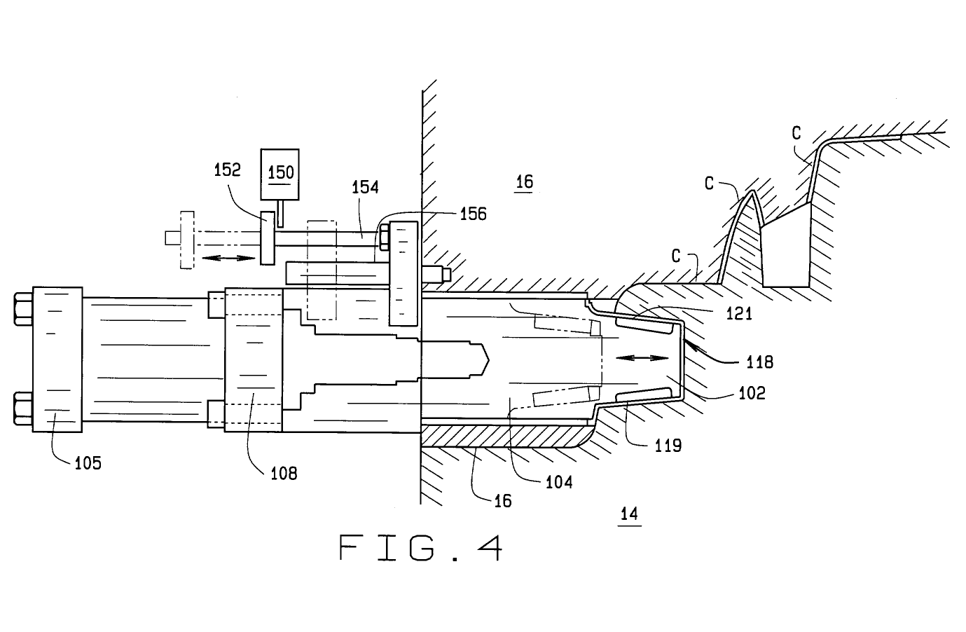

A sensing device 150 having one or more limit switches is associated with the shaft 104 and locking wedge 102 of each secondary mold lock 100. The sensing device 150 is adapted to communicate a signal representative of the position of the locking wedge 102 with an injection mold process controller (not shown). Preferably, as seen in FIG. 4, the sensing device 150 is operatively disposed adjacent the secondary lock mechanism, such that an adjustable set stop 152 disposed on a threaded shaft 154 engages the sensing device 150 at a predetermined position of the locking wedge 102. The threaded shaft 154 is coupled to the top of the shaft 104, such that the threaded shaft 154 moves synchronously with the shaft 104, along a guide rod 156 secured perpendicular to the surface of the mold element 16.

Signals provided by the sensing device 150 indicate the amount of travel of the shaft 104, and correspondingly, the position of the locking wedge 102. The signals are utilized by the injection mold process controller (not shown) to ensure the proper sequence of locking and unlocking events during an injection molding operation, thereby preventing damage to the mold unit or to the secondary lock mechanism 100 due to an inadvertent opening or closing of the mold when a secondary lock mechanism 100 is engaged.

Those of ordinary skill in the art will recognize that a variety of sensing devices 150 may be employed with the secondary mold lock unit 100 to provide a signal indicating a position, a locked state, or unlocked state. For example, a timer could be utilized to record the amount of time the secondary mold lock unit 100 requires to transition between a locked and unlocked state, or a flow indicator could be placed in the hydraulic system driving the secondary mold lock unit 100, to compare a single indicating the flow of hydraulic fluid with a known flow quantity required to transition between the locked and unlocked state.

As shown in FIGS. 2-6, at least one secondary locking unit 100 is employed to mechanically secure the mold elements 16 and 20 in their closed positions during an injection molding operation. However, those of ordinary skill in the art will readily recognize that multiple secondary locking units 100 may be disposed about the circumference of the injection mold 10, each preferably orientated normal to the mold axis MA or draw direction D, or optionally orientated at an angle relative thereto, thereby providing multiple locks to secure the mold elements 16 and 20 against movement parallel to the mold axis MA or draw direction D, in the closed position, and to provide for balanced locking of the mold elements.

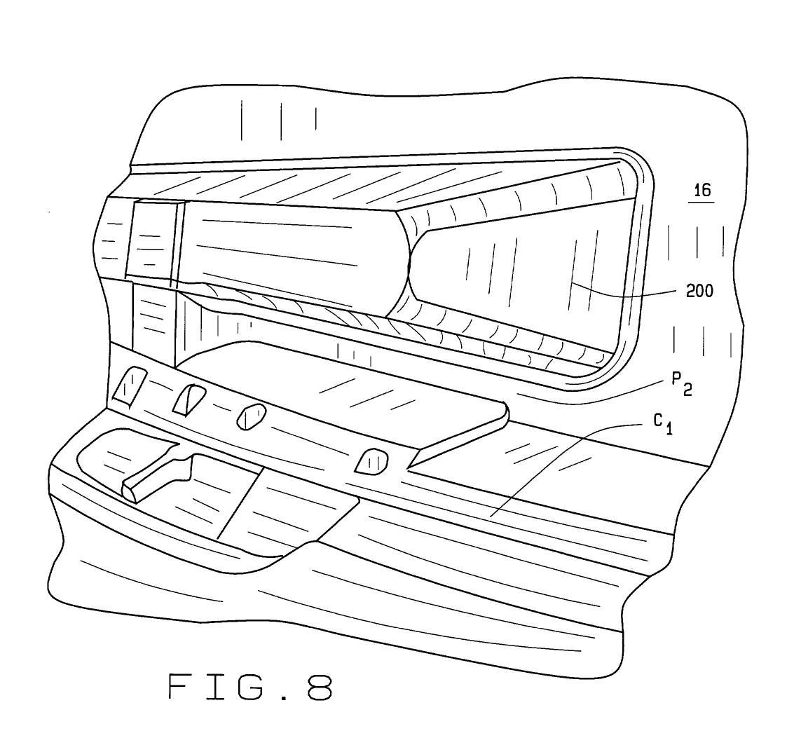

A second aspect of the present invention designed to cooperate with the secondary locking unit 100 and to further eliminate the formation of waste flash material along the edges of a finished molded product is illustrated in FIGS. 7 and 8. Conventional injection molds, such as shown in FIG. 1, utilize mold parting lines P1 between contact surfaces of the mold elements 16 and 20 which are substantially parallel to the plane of the mold base, as defined by the surface of either mold platen 12 or mold platen 14.

During the injection phase of the molding process, molten material is extruded or injected into the cavity C between the two mold elements under high pressures. The molten material does not flow into the cavity C evenly, but rather, will flow into one region C1 of the cavity C before flowing into another region C2, The cavity regions C1 and C2, as shown, are separated by a mold parting line P1, which defines a void region in the finished molded product. As the molten material flows into a first region C1 of the cavity C, it exerts forces on the mold elements 16 and 20, causing the mold elements to shift and flex internally along the mold parting line P1, normal to the mold axis MA or draw direction D. This shifting and flexing of the mold elements 16 and 20 permits small quantities of the injected molten material to extrude along the mold parting line P1, resulting in waste flash on the finished product.

As seen in FIGS. 7 and 8, to prevent the internal shifting and flexing of the mold elements along the mold parting lines, matched shear parting lines P2 are employed to define the contact surfaces between the cavity regions C1 and C2 of the two mold elements 16 and 20. Each matched shear parting line P2 is preferably orientated at an angle of 15.0 degrees relative to the mold axis MA or draw direction. The shear parting lines P2 define one or more protrusions 200 on one mold element and corresponding recesses 202 on the second mold element. The surfaces defined by the shear parting lines P2 are orientated at an angle of 15.0 degrees relative to the mold axis MA or draw direction, and provide a large contact surface area to resist internal shifting and flexing in a direction normal to the mold axis MA or draw direction D.

By resisting internal shifting and flexing along the parting lines, the shear parting lines P2 prevent the formation of waste flash material along the edges of the finished injection molded product. Those of ordinary skill in the art will recognize that the specific angle at which the shear parting lines P2 are orientated relative to the mold axis MA or draw direction D may be varied from 15.0 degrees, providing either greater or lesser degrees of resistance to flexing during the injection phase of the molding operation. Preferably, the angle of orientation is less than 45.0 degrees relative to the mold axis MA or draw direction D.

An additional feature of the shear parting lines P2 is apparent when adjustments to the closed position of the mold elements 16 and 20 is required. When conventional parting lines P1, such as shown in FIG. 1 are utilized, an adjustment to the closed position of the mold elements 16 and 20, such as to compensate for wear or distortion in one region of the mold, requires that all of the contact regions or net points at which the mold elements meet during closure be altered or machined by adding or removing material. In contrast, when the shear parting lines P2, as shown in FIG. 7 orientated at an angle relative to the mold axis MA or draw direction are utilized, only a small portion of the contact regions or net points must be altered or machined to adjust the closed position of the mold elements 16 and 20 in a specific region.

Turning next to a method of operation of an injection mold of the present invention, a primary hydraulic unit is first utilized to position the mold elements 16 and 18 along the mold axis MA or draw direction D in a closed configuration, providing contact along mold parting lines P1, or optionally along shear parting lines P2, if the mold elements 16 and 20 are so configured. Once closed, the primary hydraulic unit continues to exert a compressive holding force on the mold elements, at the desired tonnage required by the injection molding process. To secure the mold in the closed configuration one or more secondary mold locks 100 are moved at an angle relative to the mold axis MA or draw direction D, into locking engagement with corresponding tool core locks 116.

During locking engagement, the locking element of each secondary mold lock 100 passes through a tool cavity lock 114 in mold element 16, and engages matching surfaces of the corresponding tool core lock 119, positively securing the mold elements in a closed configuration and against movement parallel to the mold axis MA or draw direction D. Upon engagement between the locking elements and the tool core locks, a signal is sent from the lock sensor limit switch 150 to the mold process control unit, indicating a positive lock has been achieved, after which the injection phase of the molding process can proceed in a conventional manner.

The engagement of the locking elements of the secondary mold locks 100 with the first and second mold elements 16 and 20 prevents the mold elements from separating along the mold axis MA or draw direction D during the injection phase of the molding process. Without the use of one or more of the secondary mold locks 100, actual separation of the two mold elements along the mold axis MA or draw direction on the order of 0.008 inches has been observed, which is sufficient to cause defects in the finished product. Employing one or more secondary mold locks 100 has been found to eliminate separation of the two mold elements along the mold axis MA or draw direction D to within the a predetermined tolerance range, and to simultaneously reduce the holding force from the primary hydraulic unit (not shown) required to maintain the two mold elements in the closed position.

On molds configured with the shear parting lines P2, the surfaces defined by the shear parting lines P2 provide a large contact surface area which resists internal shifting and flexing of the mold elements in a direction normal to the mold axis MA or draw direction D during the injection phase, complimenting the operation of the secondary mold locks 100. By resisting internal shifting and flexing along the parting lines, the shear parting lines P2 prevent the formation of waste flash material along the edges of the finished injection molded product.

Following the injection phase and the cooling of the injected material, the compressive holding force of the primary hydraulic unit (not shown) is removed, and the secondary mold locks 100 are disengaged. Disengagement of the secondary mold locks 100 is registered by sensors 150, which correspondingly signal the mold process control unit to actuate the primary hydraulic unit to separate the mold elements 16 and 20 and to ejected the molded product, thereby resetting the injection mold 10 for the injection molding cycle to repeat.

Those of ordinary skill in the art will recognize that the apparatus and methods set forth herein, and specifically, the secondary mold locks 100 and shear parting lines P2 may be readily adapted without deviating from the principals of the present invention for use in injection molds 10 having more than two mold elements, and as such, the embodiments described herein utilizing only two mold elements are intended as exemplary and not as limiting.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. In an injection molding machine having at least a first mold element and a second mold element configured for movement in a draw direction between an open position and a closed position in which the mold elements define a mold cavity, an improvement comprising:
at least one lock element secured to the first mold element and configured for reciprocating movement between a retracted position in which the first and second mold elements are free to move relative to one another, and an extended position in which the first and second mold elements are mechanically interlocked in said closed position, said at least one lock element configured to engage said second mold element in said closed configuration by extending from said first mold element into said second mold element, and further configured to resist movement of said first and second mold elements in said draw direction.

2. The improved injection molding machine of claim 1 wherein said at least one lock element includes a position sensor configured to generate a signal indicative of the position of said at least one lock element along said transverse axis.

3. The improved injection molding machine of claim 2 wherein said position sensor comprises a limit switch.

4. The improved injection molding machine of claim 1 wherein said at least one lock element includes a lock wedge wedgingly engaging said second mold element when said first and second mold elements are in their closed positions thereby to positively draw and hold said mold elements into their closed positions.

5. The improved injection molding machine of claim 4 wherein said lock wedge is further adapted to receive one or more removable shims.

6. The improved injection molding machine of claim 1 wherein said at least one lock element is configured to reversibly engage said second mold element in the closed configuration with a shear fit.

7. The improved injection molding machine of claim 1 wherein said at least one lock element includes a shaft, said shaft adapted for movement through a tool cavity lock in the first mold element and for fitted engagement with an opening in said second mold element.

8. The improved injection molding machine of claim 1 wherein said at least one lock element includes a threaded shaft, said threaded shaft adapted for movement through a tool cavity lock in said first mold element and to engage a tapped bore in said second mold element.

9. The improved injection molding machine of claim 1 wherein said first mold element and said second mold element are configured for engagement along one or more shear parting lines, said one or more shear parting lines defining one or more protrusions and corresponding recesses adapted to resist movement of said first and second mold elements normal to said draw direction.

10. The improved injection molding machine of claim 9 wherein said one or more matched parting lines are orientated at an angle relative to said draw direction.

11. The improved injection molding machine of claim 10 wherein said one or more matched parting lines are orientated at an angle of less than 45.0 degrees relative to said draw direction.

12. The improved injection molding machine of claim 9 wherein said one or more protrusions and corresponding recesses provide a plurality of engaging surfaces orientated at an angle relative to said draw direction, each of said plurality of engaging surfaces adapted to resist movement of said first and second mold elements normal to said draw direction.

13. In an injection molding machine having a first mold element and a second mold element configured for movement in a draw direction between an open position and a closed position in which the first and second mold elements define a mold cavity, an improvement comprising:
said first and second mold elements adapted for closed position contact along matched parting lines, at least a portion of said matched parting lines orientated at an angle relative to said draw direction, and said portion of matched parting lines defining engaging surfaces resistant to relative movement of said first and second mold elements normal to said draw direction.

14. In an injection molding machine having a first mold element and a second mold element configured for movement in a draw direction between an open position and a closed position in which the first and second mold elements define a mold cavity, an improvement comprising:
a first means for providing a releasable positive interlock between said first and second mold elements, said first means adapted to prevent relative movement between said first and second mold elements parallel to said draw direction; and
a second means for providing a releasable positive interlock between said first and second mold elements, said second means adapted to prevent relative movement between said first and second mold elements normal to said draw direction.

15. A method for positively securing at least first and second mold elements of an injection molding apparatus in a closed configuration, comprising:
relatively moving at least one of the first and second movable mold elements along a draw direction into engagement in a closed configuration;
exerting a compressive holding force on the first and second mold elements to maintain said closed configuration; and
actuating at least one lock element along an axis orientated at an angle relative to said draw direction, said at least one lock element positively securing the first and second mold elements in the closed configuration against relative movement parallel to said draw direction.

16. The method of claim 15 for securing at least first and second mold elements wherein the step of actuating at least one lock element further comprises
reversibly driving said lock element through a bore in the first mold element transverse to said draw direction; and
engaging the second mold element with said lock element;
wherein said first and second mold elements are secured against relative movement parallel to said draw direction.

17. The method of claim 15 for securing at least first and second mold elements further including the step of generating a signal indicative of actuation of said at least one lock element along said axis.

18. The method of claim 15 for securing at least first and second mold elements further including the step of generating a signal indicative of said at least one lock element positively securing the first and second mold elements in the closed configuration.

19. The method of claim 15 for securing at least first and second mold elements further including the step of reversing said actuation of said at least one lock element prior to a withdrawing of said compressive holding force from the first and second mold elements.

20. The method of claim 15 for securing at least first and second mold elements further including the step of engaging a plurality of shear parting surfaces between said first and second mold elements, said engagement of said shear parting surfaces resisting movement of said first and second mold elements normal to said draw direction.
